(19) United States
(12) Patent Application Publication
(10) Pub. No.: US 2010/0017581 A1
(43) Pub. Date: Jan. 21, 2010

(54) LOW OVERHEAD ATOMIC MEMORY OPERATIONS

(75) Inventors: Neill M. Clift, Kirkland, WA (US); Arun U. Kishan, Bellevue, WA (US)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/176,206

(22) Filed: Jul. 18, 2008

(51) Int. Cl. G06F 9/30

(52) U.S. Cl. 712/216; 712/220; 712/E09.016

(57) ABSTRACT

Embodiments that provide low-overhead restricted memory transactions are disclosed. In accordance with one embodiment, the method includes providing one or more references to processor-specific data that corresponds to a first processor. The method further includes detecting an interrupt to the first processor when the interrupt indicates modification of the one or more references to the processor-specific data during the execution of one or more instructions. The method also includes taking remedial action on the one or more instructions when the interrupt is detected.

### BACKGROUND

In most multi-processor computer systems, each processor is allocated its own cached memory portions in a memory. The cached memory portions are also known as cache lines. If a first processor wants to modify the cached memory portions associated with a second processor, cache line migration messages must be sent to the second processor to shift the cache lines from the second processor to the first processor. However, if multiple processors continually modify the same memory cache lines, the messages may not only degrade the performance of the processors involved in the cache line tug-of-war, but may also negatively impact the performance of all processors as they consume overall memory bandwidth. Accordingly, computer codes developed for multi-processor computer systems are generally configured to minimize cache line migrations.

For example, certain multi-processors computer system may use process memory heaps to reduce cache line migration. Process memory heaps serve to segregate the memory into discrete processor areas, which reduce the need for two processors to modify the same memory. However, the use of process memory heaps still does not guarantee that a particular heap associated with a first processor will not have to be accessed by a second processor. Such heap accesses may occur due to quantum end events or other rescheduling events. Thus, computer codes that employ process memory heaps nevertheless also use process thread locks or thread interlocked sequences during memory manipulation by multiple processors. These locks can create a relatively large processing overhead for a multi-processor computer system in order to deal with generally rare situations. Moreover, in certain instances, the use of interlocked sequences or lock free sequences on memory heaps or stacks may result in bad memory references and errors.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Described herein are embodiments of various technologies for providing low overhead restricted memory transactions. In one embodiment, a reference to processor-specific data that corresponds to a first processor is provided. Further, an interrupt to the first processor is detected when the interrupt indicates modification of the at least one reference to the processor-specific data during the execution of one or more instructions. Further still, remedial action on the one or more instructions is taken when the interrupt is detected. Other embodiments will become more apparent from the following detailed description when taken in conjunction with the accompanying drawings.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIG. 1 shows an exemplary scheme for resolving interrupts to maintain low overhead atomic memory operations, in accordance with various embodiments.

FIG. 2 shows an example embodiment of low overhead atomic memory operations in which a segment register is used to detect and resolve interrupts.

FIG. 3 is a block diagram in which software flags are used in a critical region to detect and resolve interrupts for maintaining low overhead atomic memory operations, in accordance with various embodiments.

FIG. 4 is a block diagram illustrating selected components of an exemplary computing device that are configured to resolve interrupts to maintain low overhead atomic memory operations, in accordance with various embodiments.

FIG. 5 is a flow diagram illustrating an exemplary process for resolving interrupts to maintain low overhead atomic memory operations using a segment register, in accordance with various embodiments.

FIG. 6 is a flow diagram illustrating an exemplary process for resolving interrupts to maintain low overhead atomic memory operations using software flags, in accordance with various embodiments.

FIG. 7 is a block diagram illustrating a representative computing device on which resolving interrupts to maintain low overhead atomic memory operations is implemented, in accordance with various embodiments, may be implemented.

### DETAILED DESCRIPTION

This disclosure is directed to embodiments that enable low overhead atomic memory operations. Atomic memory operations are a set of operations performed in memory such that they appear to the rest of the computing system as a single memory operation. Atomic memory operations typically generate two outcomes: (1) successful execution of the operation; or (2) failure to execute the operation. In order to accomplish an atomic memory operation, no other process can change the atomic memory operation. Further, if any step that is part of the atomic operation fails, then the entire operation will fail and the data affected by the atomic operation will be restored to its original state.

For example, a processor may be instructed to execute a sequence of instructions. The instructions may include a plurality of data manipulation instructions and a “commitment” instruction to store the final outcome for output. In order to process the sequence of instructions as an atomic operation, the processor may abandon the current operation and restart the execution of the instructions if an interrupt occurs prior to the “commitment” instruction. In one instance, the interrupt may occur as result of an operating system context switch. In another instance where the processor is part of a multi-processor system, the data processed by a first processor may be a global variable, and therefore an interrupt may occur when a second processor of the multi-processor system carries out a process that concurrently modifies the global variable. Thus, abandoning the current execution of the sequence of instructions and reinitializing the execution may ensure that the instructions are executed as an atomic operation.

The embodiments described herein are directed to technologies for the detection of interrupts to the execution of a sequence of instructions. As described, the interrupt detection mechanisms may use a specialized register segment in memory and/or software flags that mark critical regions of process threads. Once an interrupt is detected, the occurrence of the interrupt may be passed on to an application, such as an operating system, that takes the appropriate remedial action. For instance, an operating system may abort the execution of the instructions (e.g., via an exception). In other instances, the operating system may terminate a process thread that includes the instructions, and/or reinitialize the execution of the instructions. In this way, the embodiments described herein may reduce or eliminate the use of thread locks or thread interlocked sequences during the processing of instructions by multi-processor computing systems. Thus, the need for additional software overhead and special hardware associated with thread locks or thread interlocked sequences may also be reduced or eliminated.

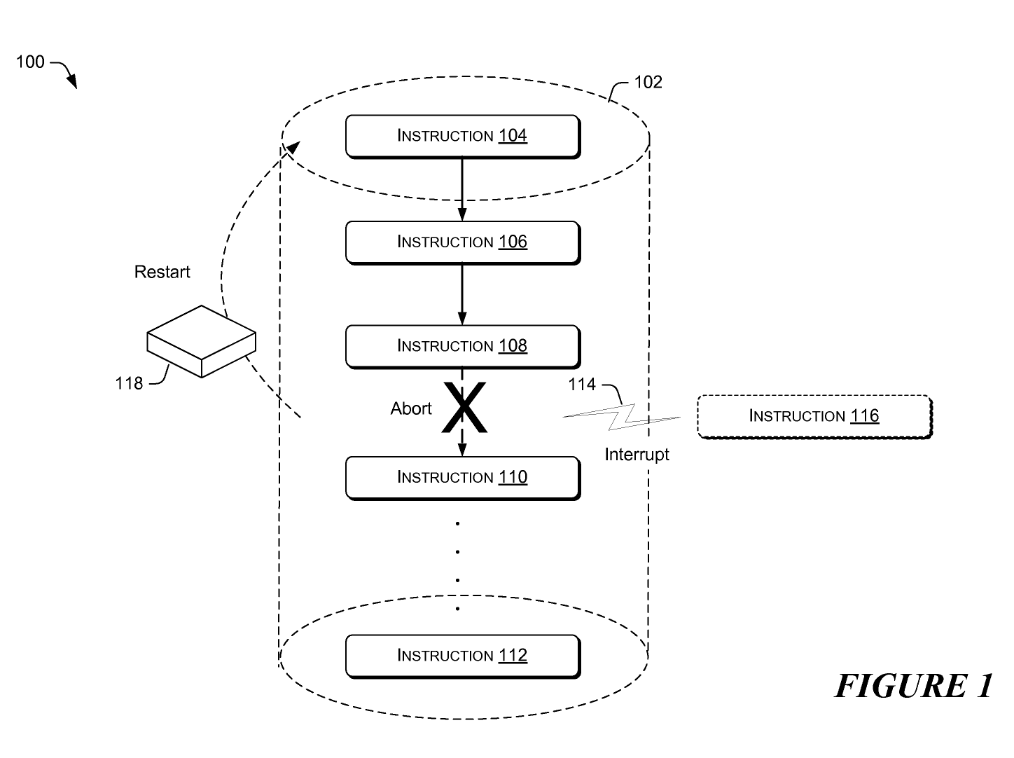

Various examples of facilitating differentiated access to networked resources based on the attributes of authentication inputs are described below with reference to FIGS. 1-7.

### Exemplary Schemes

FIG. 1 illustrates an exemplary scheme 100 for resolving interrupts to maintain low overhead atomic memory operations, in accordance with various embodiments. As shown, a process thread 102, as executed by a processor, may include the execution of a sequence of instructions, such as instructions 104-112. It will be appreciated that the instructions 104-112, as shown, are merely illustrative, and the actual number of instructions in a process thread 102 may vary.

In various instances, the instructions 104-112 may include data manipulation instructions as well as a commitment instruction. In one instance, the data manipulation instructions, such as instructions 104-110, are instruction that do not modify any global visible states. For example, instructions 104-110 may be instructions that load, swap, or perform arithmetic operations on the data. In the same example, instruction 112 may be a commitment instruction that stores the manipulated data for final output, such as to another process. Accordingly, instructions 104-112 may be executed sequentially.

In some instances, the execution of the instructions 104-112 may be disrupted by an interrupt 114. The interrupt 114 may be caused by the execution of an instruction 116 that is not part of the process thread 502. In some instances, the interrupt 114 may occur as a result of an operating system context switch. A context switch is a mechanism that switches a processor from executing a first process thread, such as the process thread 102, to a second thread (not shown) that includes an instruction 116.

In other instances involving multi-processor computer systems, one or more of the instructions 104-110 may be instructions that act on data that include a global variable. Accordingly, the interrupt 114 may be caused by a second processor that accesses the data concurrently in order to modify the global variable with the instruction 116. Such an access by the second processor may cause a race condition to occur. The race condition may alter the data being manipulated by the instructions 104-110, so that the instructions 104-110 may produce an unexpected result.

In accordance with various embodiments, a program module, such as an interrupt handler 118, may detect the occurrence of the interrupt 114. Subsequently, the handler may resolve the interrupt by taking remedial action. In some embodiments, the interrupt handler 118 may direct the processor to abort the execution of the process thread 102 and/or termination of the process thread 102. In additional embodiments, the interrupt handler 118 may further direct the processor to reinitialize the execution of the instructions 104-112 in the process thread 102. In other words, the processor may reset to an original state and repeat the execution of the process thread 102 from the initial instruction 104 on the data. In this way, the interrupt handler 118 may ensure that the process thread 102 is executed as an atomic operation.

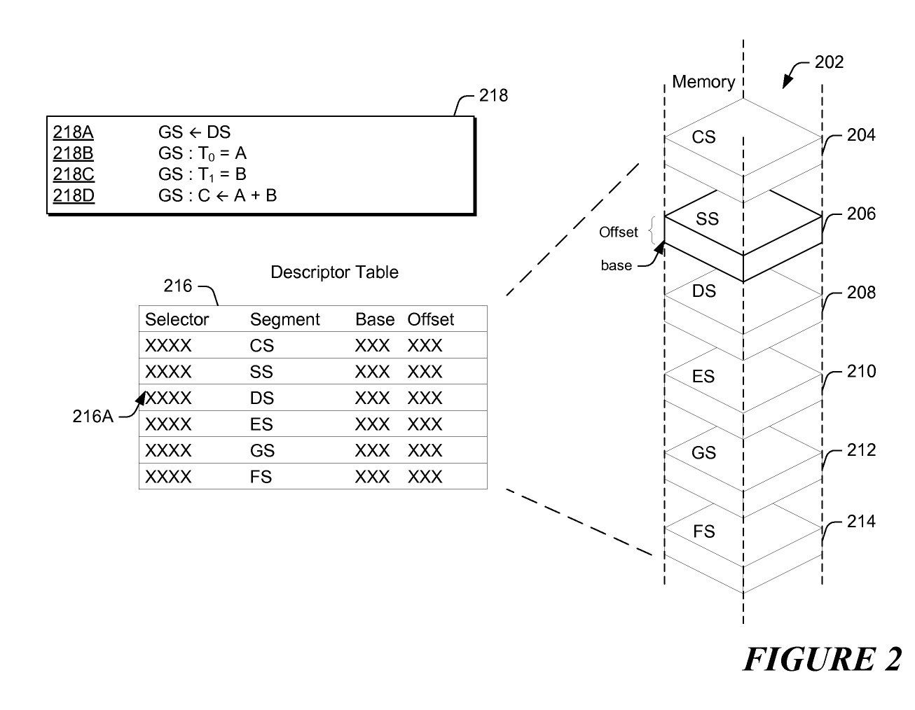

FIG. 2 illustrates the use of a segment register to detect and resolve interrupts to maintain low overhead atomic memory operations, in accordance with various embodiments. In some embodiments, the segment register used to resolve interrupts for the purpose of atomic memory operations may be a segment register that is found in an x86 memory segmentation scheme. As used herein, x86 memory segmentation refers to the implementation of memory segmentation on the x86 architecture. In turn, x86 architecture refers to an instruction set and central processing unit (CPU) architecture originally designed by the Intel® Corporation of Santa Clara, Calif. A number of operating systems have been developed for the x86 architecture. For example, these operating systems may include the various Windows® operating systems developed by the Microsoft Corporation of Redmond, Wash.

As shown in FIG. 2, the x86 memory segmentation scheme may divide a certain portion of a memory, such as memory 202, into six memory segments. These memory segments include CS 204, SS 206, DS 208, ES 210, GS 212, and FS 214. Each of these memory segments may be associated with a segment register. In turn, each of the memory registers may contain an index to a Global Descriptor Table (GDT) or a Local Descriptor Table (LDT), as represented by the exemplary descriptor table 216. The descriptor table 216 may define the characteristics, or descriptors, of the memory segments 204-214. For example, the descriptor table 216 may denote the beginning of a segment, or base, in a memory, as well as a value that identifies the range of the segment in the memory, which is known as an offset. For example, the exemplary descriptor table 216 may indicate that a memory segment has a hexadecimal base address of 0x0CEF0, and an offset of 0xC000.

In illustrative embodiments where the operating system is a Windows® operating system running in native 32 bit mode, the base value for each of the memory segments CS, SS, DS, and ES may be set to zero in a GDT or LDT, as represented by exemplary descriptor table 216. Similarly, the offset for the memory segments CS, SS, DS, and ES in a GDT or LDT may also be set to the maximal 32 bit length to cover the entire range of available memory 202, thereby converting the memory segments 204-210 into flat memory segments.

Furthermore, the FS segment is used to locate the thread environment block (TEB). Accordingly, the base value of the FS segment may be set to the TEB address, and its offset modified to contain the entire TEB. However, the GS segment is unused in a Windows® operating system functioning in native 32 bit mode. Moreover, the GS segment register corresponding to the GS segment may be set to an invalid value, such as the NULL (zero) segment selection if an interrupt, such as a context swap, occurs during the processing of a process thread, such as process thread 102 (FIG. 1). The set of an invalid value, or “zero out” of the GS segment register may further generate a “trap”, that is, fault that is readily detectable by a software mechanism, such as an interrupt handler 118. Thus, because of this unique property of the GS segment register in the Windows® native 32 bit mode, the GS segment register can be used as a mechanism to detect and abort sequences of operations if a context swap occurs.

The operation of the GS segment register to detect interrupts may be further explained with reference to exemplary instructions 218. As shown, instruction 218A may load the GS segment register with the DS segment descriptors (i.e., base address and offset). In one embodiment, the instruction 218 may cause the DS segment descriptors to be loaded to the GS segment register by using a selector value 216A in the descriptor table 216 that corresponds to the DS segment descriptors. Following the loading of the DS segment descriptors into the GS segment register, any subsequent memory operations to the DS segment, such as an instruction that loads a value “A” at time T₀ (instruction 218B), can only be carried out through the GS selector if the GS segment register is not set to NULL. This “prefixing” of the GS segment register as an “override” to memory operations in the DS segment is represented by the notation “GS: T₀=A” (instruction 218B).

Accordingly, if an interrupt occurs following operation 218B, then the GS segment register will zero out and generate a fault. The fault may be detected by an interrupt handler, such as the interrupt handler 118. The interrupt handler may then causes a processor to abort the executions of instructions 218C and 218D. Thus, an instruction that loads a value “B” at time T₁ (instruction 218D), and an instruction that store “A” and “B” to location “C” (instruction 218D) will not be executed. It will be appreciated that once the DS segment descriptors are loaded into GS segments, instructions 218B-218D may be any instructions in a process thread, such as process thread 102 (FIG. 1). In some embodiments, the interrupt handler 118 may also cause the processor to restart the execution of instructions 218B-218D. However, in other embodiments, the interrupt handler 118 may report the occurrence of the interrupt to a program (e.g., an operating system handling the execution of the process thread 102). The program may then determine whether the execution of the instructions 218B-218D, as affected by the interrupt, should be aborted and/or restarted.

While the use of a segment register to detect and resolve interrupts may be illustrated with respect to a Windows® operating system and a GS segment register, it will be appreciated that such use may also be implemented on other computer architectures and operating system environments. For example, any segment register of segment architecture that is capable of being “zeroed out” by an interrupt may be used directly, or indirectly as a “prefix” to another memory segment that handles memory references, to cause an abort and/or restart of execution for a sequence of instructions. In other embodiments, any hardware state that can be set by a hardware and/or operating system, where the hardware state may be appended as a predicate “prefix” to an instruction, may be used to detect an interrupt as described above, as well as cause an abort and/or restart of execution for a sequence of instructions.

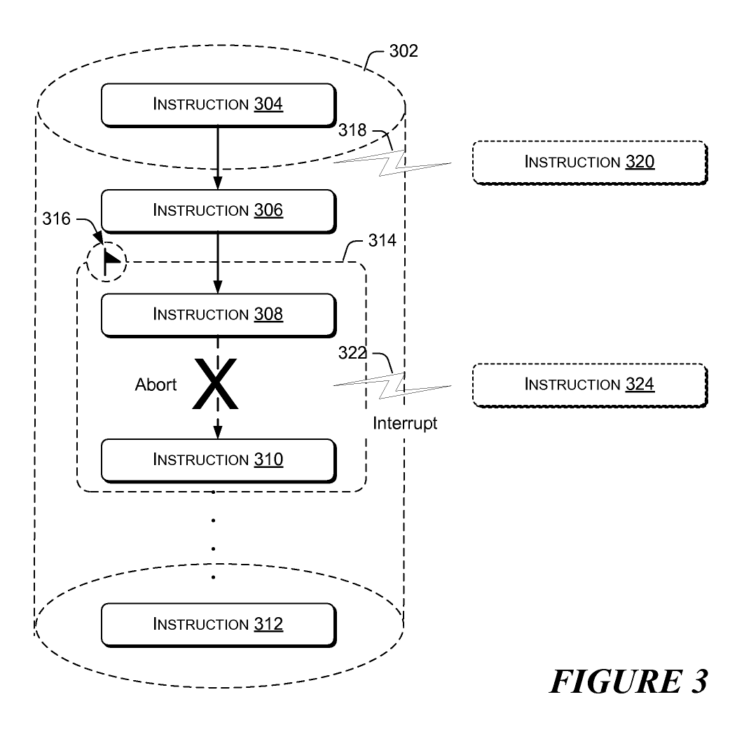

FIG. 3 is a block diagram illustrating the use of software flags in a critical region to detect and resolve interrupts for maintaining low overhead atomic memory operations, in accordance with various embodiments. As shown, a process thread 302, as executed by a processor, may include the execution of a sequence of instructions, such as instructions 304-312. It will be appreciated that the instructions 304-312, as shown, are merely illustrative, and the actual number of instructions in a process thread 302 may vary.

In various instances, the instructions 304-312 may include data manipulation instructions as well as a commitment instruction. For example, instructions 304-310 may be instructions that load, swap, or perform arithmetic operations on the data. In the same example, instruction 312 may be a commitment instruction that stores the manipulated data for final output, such as to another process. Accordingly, instructions 304-312 may be executed sequentially.

The process thread 302 may include one or more instructions, such as instructions 308-310, that are in a critical region 314. As used herein, a critical region includes instructions of a process thread that manipulate shared data. Shared data are data that may are capable of being manipulated by multiple process threads. For example, in a multi-process computer system, the system may be configured to execute multiple threads running on different processors that can manipulate the same global variable.

In various embodiments, in order to prevent the occurrence of race conditions, instructions in a critical region may be marked with one or more software flags. For example, a computer code that creates the process thread 302 may mark the instructions 308-310 with a software flag 316 to denote the fact they are in the critical region 314. The software flag 316 may be stored in a thread associated with the process thread 302.

As shown in FIG. 3, the marking of instructions in the critical region 314 with a software flag 316 may prevent race conditions. For example, during the execution of the process thread 302 by a processor, an interrupt 318 created by an instruction 320 may occur following the processing of instruction 304. The instruction 320 may not part of the process thread 302, but may be part of a separate thread that was processed due to a context switch. During an exemplary context switch, the processor may handle the context switch by suspending the execution of the processor thread 302, saving the state of the processor, process instruction 320 (which may belong to a process thread), saving the state of the processor, then eventually retrieving the state associated with the process thread 302, and resuming processing. Since the instruction 304 is not in a critical region, an interrupt handler, such as the interrupt handler 118 (FIG. 1) may ignore the processing of the instruction 320 by the processor. In contrast, as the instruction 308 of the process thread 302 is being processed by the processor, the interrupt handler 118 may note that the instruction 308 is marked by a software flag 316. The software flag 316 may indicate that instruction 308 is in the critical region 314. Subsequently, in the event that the execution of the process thread 302 is disputed by an interrupt 322 caused by the executing of instruction 324, the interrupt handler 118 may generate an exception because software flag 316 is present. The interrupt handler 118 may then reflect the exception to the processor to cause an abort of thread execution and/or termination of the process thread 302. In some embodiments, the interrupt handler 118 may further direct the processor to reinitialize the execution of the instructions 304-312 in the process thread 302. It will be appreciated that once the interrupt handler 118 has recognized that the processing of an instruction in a critical region, such as instruction 308 in critical 316, is followed by an interrupt, the interrupt handler 118 may be configured to abort thread execution and/or terminate the corresponding process thread, such as process thread 302, at any point subsequent to the instruction and prior to a commitment instruction.

For example, in some embodiments, the interrupt handler 118 may permit the processor to process one or more additional instructions prior to aborting the execution of the process thread 302 and/or terminating the processing thread 302 prior to the commitment instruction 312. Moreover, in additional embodiments the interrupt handler 118 may be configured to report the interrupt to the critical region 314 to a program (e.g., an operating system handling the execution the process thread 302).

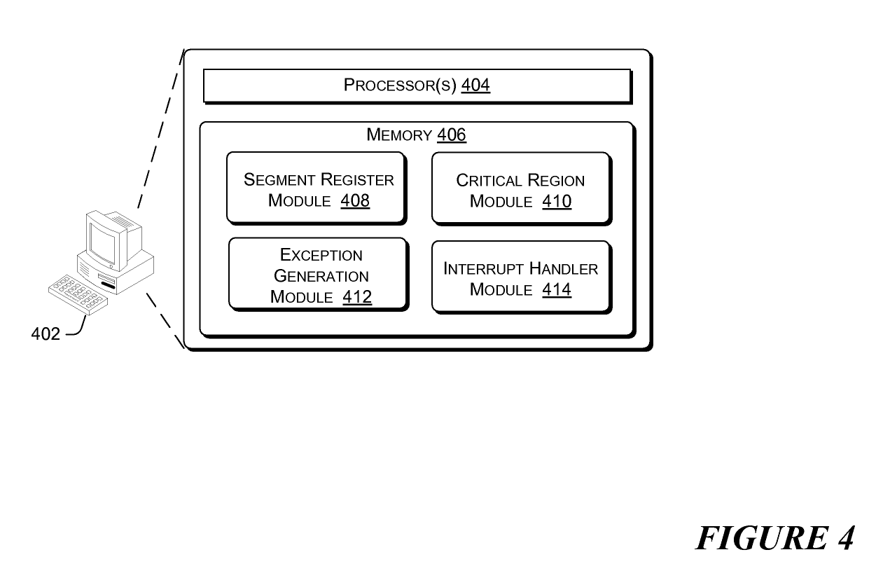

FIG. 4 illustrates selected components of an exemplary computing device 402. The computing device 402 may include software and hardware components that are configured to resolve interrupts to maintain low overhead atomic memory operations, in accordance with various embodiments. The computing device 402 may include one or more processors 404 and memory 406. The one or more processors 404 are configured to execute process threads, such as the process thread 102 (FIG. 1). The memory 406 may include volatile and/or nonvolatile memory, removable and/or non-removable media implemented in any method or technology for storage of information, such as computer-readable instructions, data structures, program modules or other data. Such memory may include, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and is accessible by a computer system.

Program instructions, or modules, may be stored in the memory 406. The program instructions may be configured to resolve interrupts to maintain low overhead atomic memory operations. The program instructions may include routines, programs, objects, components, and data structures that perform particular tasks or implement particular abstract data types. The selected program instructions may include a critical region module 408, an interrupt handler module 410, an exception generation module 412, and a segment register module 414. Furthermore, these modules may be part of the interrupt handle 118, as described in FIG. 1. It will be appreciated that the exemplary computing device 402 may include other components necessary for the execution of instructions in process threads.

The segment register module 408 may be configured to designate a segment register as an override “prefix” to a different memory segment to detect interrupts. For example, as described above, the segment register module 408 may designate the GS segment register as an override “prefix” to the DS memory segment in an x86 system architecture. In other embodiments, the segment register module 408 may designate other segment registries as “prefixes”, as long as such segment registries are capable of “zeroing out” or generate a fault in the event of an interrupt to the executing of process thread. In still other embodiments, the segment register module 408 may be configured to create a new register, rather than designating an existing register, that performs substantially the same function as the GS segment register described above.

The critical region module 410 may be configured to recognize software flags that designate instructions in a process thread as in a critical region. As described above, instructions executed by a processor may be pre-designated with one or more software flags. The critical region module 410 may be employed to recognize a software flag as an instruction of a process thread is being processed. Upon recognition of the software flag, the critical region module 410 may provide such information to an exception generation module 412.

The exception generation module 412 may be configured to raise an exception when the data manipulated by an instruction of a first process thread designated with a software flag is manipulated by an instruction of a second process thread. In other words, the exception may be raised by the exception generation module 412 when an interrupts occurs following the process of an instruction in a critical region. The exception generation module 412 may be further configured to pass the exception to the interrupt handler module 414.

The interrupt handler module 414 may be configured to abort the execution of a process thread by a processor when an interrupt occurs. In other embodiments, the interrupt handler 414 may be configured to terminate the process thread when an interrupt occurs. In some embodiments, the interrupt handler module 414 may be configured to abort the execution of a process thread and/or terminate the execution thread when a GS segment register, or another segment register, which acts as a “prefix” to another memory segment indicates that can interrupt occurred. In other embodiments, the interrupt handler module 414 may be configured to deliver an exception generated by an exception generation module 412. In one embodiment, the interrupt handler module 414 may abort the execution of and/or terminate a process thread that includes one or more instructions in a critical region. In various embodiments, the interrupt handler module 414 may cause an immediate abort of execution and/or termination of the process thread in response to an exception. In other embodiments, the interrupt handler module 414 may be configured to permit the execution of one or more additional instructions in a process thread following an exception, before aborting the execution and/or terminating the process thread.

### Exemplary Processes

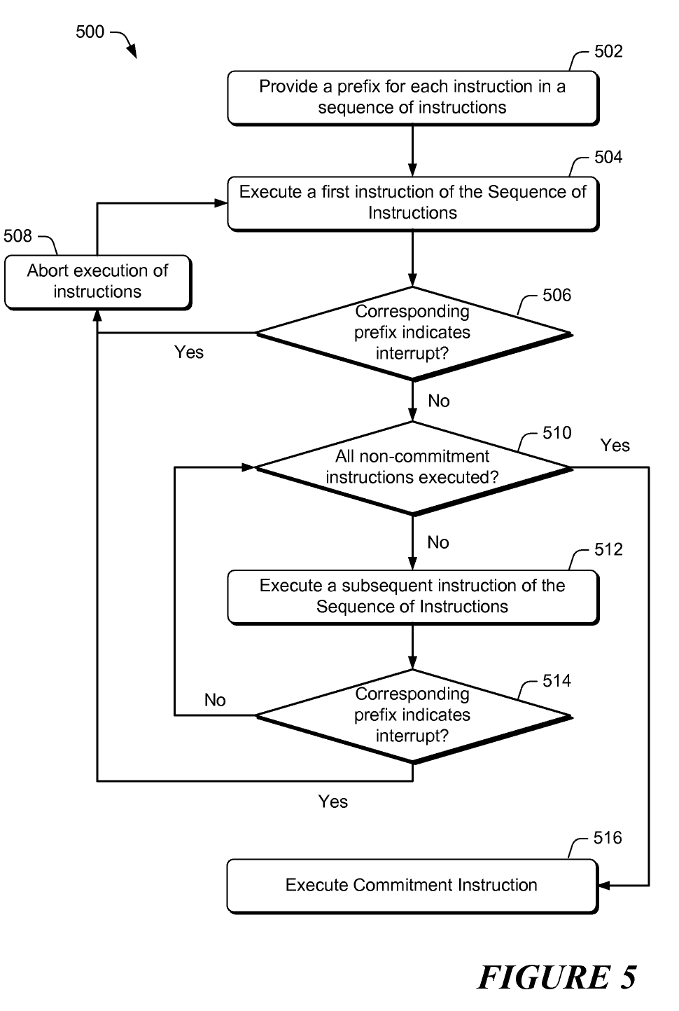

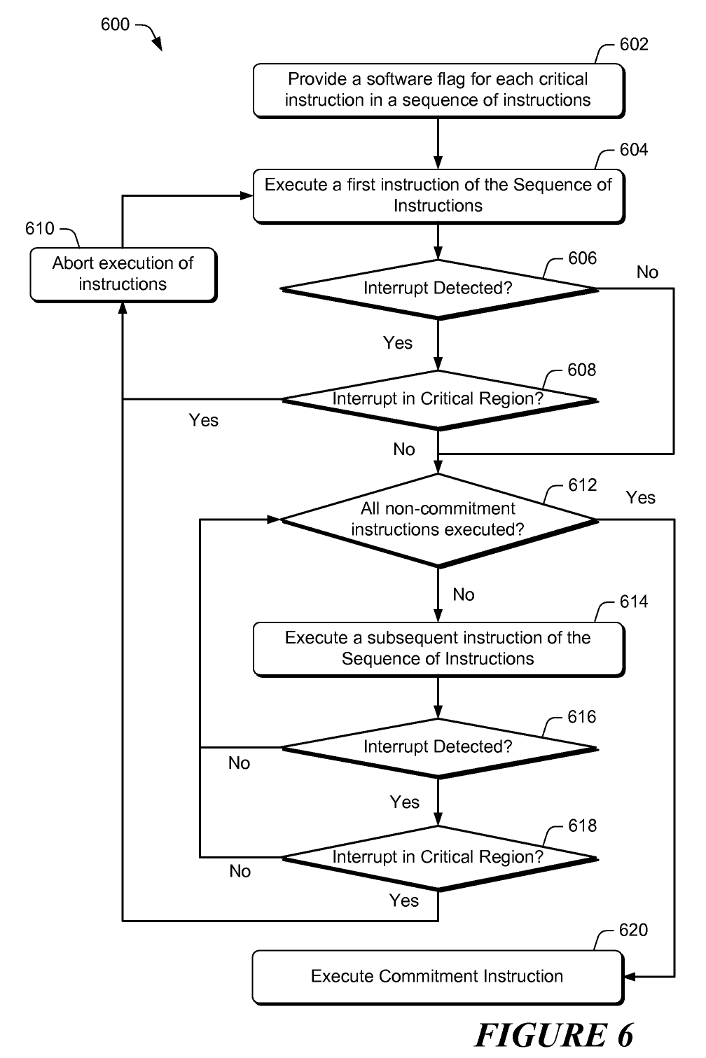

FIGS. 5-6 illustrate an exemplary process that resolving interrupts to maintain low overhead atomic memory operations, in accordance with various embodiments. The exemplary processes in FIGS. 5-6 are illustrated as a collection of blocks in a logical flow diagram, which represents a sequence of operations that can be implemented in hardware, software, and a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes are described with reference to the exemplary computing device 402 of FIG. 4, although they may be implemented in other system architectures.

FIG. 5 is a flow diagram illustrating an exemplary process 500 for resolving interrupts to maintain low overhead atomic memory operations using a segment register, in accordance with various embodiments.

At block 502, a “prefix” may be provided for each instruction in a sequence of instructions in a process thread, such as the process thread 102. As described above, in various embodiments involving the x86 architecture, the “prefixes” may be provided by loading a GS segment register with descriptors for the DS memory segment. In this way, the GS segment register may provide an interrupt “override” to each instruction in the process thread 102.

At block 504, a processor may initialize the executing of the process thread by processing the first instruction in the process thread.

At decision block 506, an interrupt handler, such as the interrupt handler 118, may determine whether the prefix segment register indicates that an interrupt occurred following the execution of the first instruction. For example, the segment register may indicate the occurrence of an interrupt that is the result of a context swap. If the interrupt handler determines that no interrupt occurred (“no” at decision block 506), the process 500 may proceed to decision block 510. However, if the interrupt handler determines that an interrupt occurred, (“yes” at decision block 506), the process 500 may proceed to block 508.

At block 508, the interrupt handler may cause the processor to abort the execution of the instructions of the process thread and/or terminate the process thread. In some embodiments, following the abort of execution and/or termination of the process thread, the process 500 may loop back to block 504, where the interrupt handler may further cause the processor to reinitialize the execution of the first instruction of the process thread. In other words, the processing of the thread may be restarted.

Returning to decision block 510, a determination may be made as to whether all of non-commitment instructions of the process thread are processed. As used herein, non-commitment instructions are instructions that manipulate data, but do not store, load, or output the final state of the data. If it is determined that not all of the non-commitment are processed (“no” at decision block 510), the process 500 may proceed to block 512.

At block 512, the processor may process a subsequent instruction of the process thread.

At decision block 514, the interrupt handler may determine whether the prefix segment register indicates that an interrupt occurred following the execution of the subsequent instruction. If the interrupt handler determines that no interrupt occurred (“no” at decision block 514), the process 500 may loop back to decision block 510, wherein each of the subsequent non-commitment instructions may be processed.

However, if the interrupt handler determines that an interrupt occurred, (“yes” at decision block 514), the process 500 may loop back to block 508, where the interrupt handler may cause processor to abort the processing of the instructions, termination of a process thread that includes the instructions, and/or restart of the process thread.

Returning to decision block 510, if it is determined that all of the non-commitment instructions are processed, (“yes” at decision block 510), the process 500 may proceed to block 516, where the commitment instruction may be carried out to complete the execution of the process thread. It will be appreciated that the process 500 ensures that the execution of the process thread is implemented in an atomic operation.

FIG. 6 is a flow diagram illustrating an exemplary process 600 for resolving interrupts to maintain low overhead atomic memory operations using software flags, in accordance with various embodiments.

At block 602, instructions of a process thread that are in critical regions may be provided with software flags. As described herein, a critical region includes instructions of a process thread that manipulate shared data. Shared data are data that may are capable of being manipulated by multiple process threads.

At block 604, a processor may initialize the executing of the process thread by processing the first instruction in the process thread.

At decision block 606, an interrupt handler, such as the interrupt handler 118, may make a determination as to whether an interrupt occurred. For example, the interrupt may be caused by a context swap or a second processor initiating the interruption before executing an instruction that manipulates the same data as the first instruction. If the interrupt handler detects at an interrupt at decision block 606, (“yes” at decision block 606), the process 600 may proceed to decision block 608.

At decision block 608, the interrupt handler may further determine whether the interrupt occurred following the execution of an instruction that is in a critical region. If the interrupt occurred in a critical region (“yes” at decision block 608), the process 600 may proceed to block 610.

At block 610, the interrupt handler may cause the processor to abort the execution of the instructions of the process thread and/or termination of a process thread that includes the instructions. In some embodiments, following the abort of the process thread, the process 600 may loop back to block 604, where the interrupt handler may further cause the processor to reinitialize the execution of the first instruction of the process thread. In other words, the processing of the thread may be restarted. However, if the interrupt handler determines at decision block 608 that the interrupt did not occur following the execution of an instruction that is in a critical region (“no” at decision block 608), the process may proceed to decision block 612.

Returning to block 606, if the interrupt handler does not detect an interrupt (“no” at block 606), the process 600 may proceed directly to decision block 612.

At decision block 612, a determination may be made as to whether all of non-commitment instructions of the process thread are processed. As used herein, non-commitment instructions are instructions that manipulate data, but do not store, load, or output the final state of the data. If it is determined that not all of the non-commitment are processed (“no” at decision block 612), the process 600 may proceed to block 614.

At block 614, the processor may process a subsequent instruction of the process thread.

At decision block 616, the interrupt handler may make a second determination as to whether an interrupt occurred. If the interrupt handler detects at an interrupt at decision block 616, (“yes” at decision block 616), the process 600 may proceed to decision block 618. At decision block 618, the interrupt handler may further determine whether the interrupt occurred following the execution of an instruction that is in a critical region. If the interrupt occurred in a critical region, the process 600 may loop back to block 610.

At block 610, the interrupt handler may cause the processor to abort the execution of the instructions of the process thread and/or termination of a process thread that includes the instructions. However, if the interrupt handler determines at decision block 618 that the interrupt did not occur following the execution of an instruction that is in a critical region, the process may further loop back to decision block 612, so that additional subsequent non-commitment instructions may be processed.

Returning to decision block 616, if the interrupt handler does not detect an interrupt at the decision block 616, (“no” at decision block 616), the process 600 may return to decision block 612. However, at decision block 612, if it is if it is determined that all of the non-commitment instructions are processed, (“yes” at decision block 612), the process 600 may proceed to block 620, where the commitment instruction may be carried out to complete the execution of the process thread.

It will be appreciated that the process 600 ensures that the execution of the process thread is implemented in an atomic operation.

### Exemplary Computing Environment

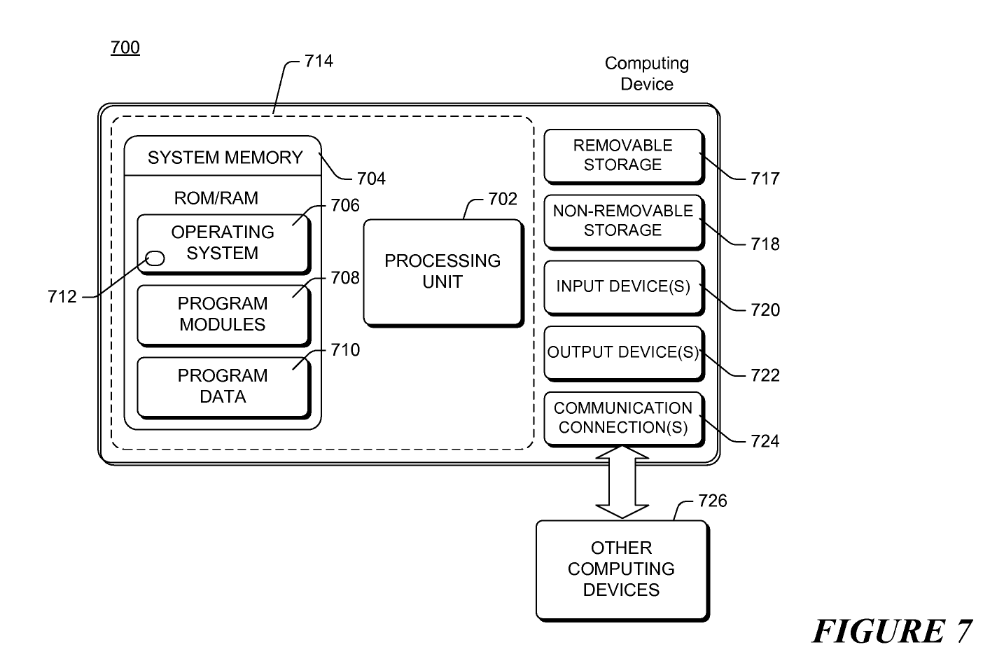

FIG. 7 illustrates a representative computing environment 700 that may be used to implement techniques and mechanisms for resolving interrupts to maintain low overhead atomic memory operations, in accordance with various embodiments described herein. The computing device 402, as described in FIG. 4, may be implemented in the computing environment 700. However, it will readily appreciate that the techniques and mechanisms may be implemented in other computing devices, systems, and environments. The computing environment 700 shown in FIG. 7 is only one example of a computing device and is not intended to suggest any limitation as to the scope of use or functionality of the computer and network architectures. Neither should the computing environment 700 be interpreted as having any dependency or requirement relating to any one or combination of components illustrated in the example computing device.

In a very basic configuration, computing device 700 typically includes at least one processing unit 702 and system memory 704. Depending on the exact configuration and type of computing device, system memory 704 may be volatile (such as RAM), non-volatile (such as ROM, flash memory, etc.) or some combination of the two. System memory 704 typically includes an operating system 706, one or more program modules 708, and may include program data 710. The operating system 706 includes a component-based framework 712 that supports components (including properties and events), objects, inheritance, polymorphism, reflection, and provides an object-oriented component-based application programming interface (API), such as, but by no means limited to, that of the .NET™ Framework manufactured by the Microsoft Corporation, Redmond, Wash. The device 700 is of a very basic configuration demarcated by a dashed line 714. Again, a terminal may have fewer components but will interact with a computing device that may have such a basic configuration.

Computing device 700 may have additional features or functionality. For example, computing device 700 may also include additional data storage devices (removable and/or non-removable) such as, for example, magnetic disks, optical disks, or tape. Such additional storage is illustrated in FIG. 7 by removable storage 716 and non-removable storage 718. Computer storage media may include volatile and nonvolatile, removable and non-removable media implemented in any method or technology for storage of information, such as computer readable instructions, data structures, program modules, or other data. System memory 704, removable storage 716 and non-removable storage 718 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 700. Any such computer storage media may be part of device 700. Computing device 700 may also have input device(s) 720 such as keyboard, mouse, pen, voice input device, touch input device, etc. Output device(s) 722 such as a display, speakers, printer, etc. may also be included. These devices are well known in the art and are not discussed at length here.

Computing device 700 may also contain communication connections 724 that allow the device to communicate with other computing devices 726, such as over a network. These networks may include wired networks as well as wireless networks. Communication connections 724 are some examples of communication media. Communication media may typically be embodied by computer readable instructions, data structures, program modules, etc.

It is appreciated that the illustrated computing device 700 is only one example of a suitable device and is not intended to suggest any limitation as to the scope of use or functionality of the various embodiments described. Other well-known computing devices, systems, environments and/or configurations that may be suitable for use with the embodiments include, but are not limited to personal computers, server computers, hand-held or laptop devices, multiprocessor systems, microprocessor-base systems, set top boxes, game consoles, programmable consumer electronics, network PCs, minicomputers, mainframe computers, distributed computing environments that include any of the above systems or devices, and/or the like.

The provision of the ability to detect interrupt for the purpose of aborting and/or restarting process thread may advantageously prevent race conditions and/or ensure that the instructions in a process threads are carried out in an atomic operation. Thus, embodiments in accordance with this disclosure may serve to ensure that the data manipulated by process thread are not corrupted by race conditions.

### Conclusion

In closing, although the various embodiments have been described in language specific to structural features and/or methodological acts, it is to be understood that the subject matter defined in the appended representations is not necessarily limited to the specific features or acts described. Rather, the specific features and acts are disclosed as exemplary forms of implementing the claimed subject matter.

1. A method, comprising:
providing at least one reference to processor-specific data that corresponds to a first processor;
detecting an interrupt to the first processor when the interrupt indicates modification of the at least one reference to the processor-specific data during execution of one or more instructions; and
taking remedial action on the one or more instructions when the interrupt is detected.

2. The method of claim 1, wherein the taking remedial action includes at least one of restarting the execution of the one or more instructions, aborting the execution of the one or more instructions, terminating a process thread that includes the one or more instructions, or reporting the interrupt to an application.

3. The method of claim 1, wherein the providing at least one reference includes providing one of at least one software flag that causes an exception following the interrupt or a hardware register that is reset by the interrupt.

4. The method of claim 1, wherein the providing at least one reference includes providing a x86 GS segment register that is resettable to a zero value by the interrupt.

5. The method of claim 1, wherein the providing at least one reference includes providing at least one reference to a critical region in the processor-specific data.

6. The method of claim 1, wherein the providing at least one reference includes providing one of at least one software flag or a hardware register, and wherein the detecting an interrupt includes detecting the interrupt when the interrupt clears the at least one software flag or resets the hardware register.

7. The method of claim 1, wherein the detecting an interrupt includes checking for the interrupt after execution of each of the one or more instructions.

8. The method of claim 1, wherein the detecting an interrupt includes detecting an access to the process-specific data by a second processor.

9. The method of claim 1, wherein the detecting the occurrence of an interrupt includes detecting an access to the process-specific data that is initiated by one of a context switch or an instruction executed on the second processor.

10. A computer readable medium storing computer-executable instructions that, when executed, cause one or more processors to perform acts comprising:
determining a critical region that includes an instruction of a sequence of instructions;
executing one or more instructions of the sequence of instructions on a first processor;
detecting an interrupt during the executing of the instruction that is included in the critical region; and
resolving the executing of the one or more instructions of the sequence of instructions on a first processor.

11. The computer readable medium of claim 10, wherein the resolving the executing of the one or more instructions includes at least one of restarting the executing of the one or more instructions, aborting the executing of the one or more instructions, or terminating a process thread that includes the one or more instructions.

12. The computer readable medium of claim 10, wherein the determining a critical region includes one of marking the critical region with a software flag that raises an exception following the interrupt or a providing a hardware register that is resettable by the interrupt.

13. The computer readable medium of claim 10, wherein the detecting an interrupt triggers the resolving the executing of the one or more instructions.

14. The computer readable medium of claim 10, wherein the detecting an interrupt includes detecting an access to the critical region that is initiated by one of a context swap or an instruction executed on the second processor.

15. The computer readable medium of claim 10, wherein the detecting an interrupt comprises one of reflecting an exception to a process thread executing the instruction corresponding to the critical region or reset a hardware register upon a fault caused by the interrupt.

16. The computer readable medium of claim 10, wherein the determining a critical region includes using a x86 GS segment register that is resettable to a zero value by the interrupt.

17. The computer readable medium of claim 10, comprising further instructions that cause the one or more processors to perform an act comprising providing data regarding the interrupt to a computer code that includes the sequence of instructions.

18. The computer readable medium of claim 10, comprising further instructions that cause the one or more processors to perform an act comprising providing data regarding the interrupt to a computer code that includes the sequence of instructions following one of the detecting of the interrupt or the execution of sequence of instructions and prior to commitment.

19. A data structure, comprising:
a memory to store at least one thread to processor-specific data in a critical region, the processor-specific data corresponding to a first processor; and
a thread field to store at least one software flag, wherein:
the software flag is to denote that the thread to the processor-specific data is being processed by the first processor, and
the software flag is to be used by a computer code to cause processing of processor-specific data by the first processor to terminate when the processing is interrupted by a second processor.

20. The data structure of claim 19, wherein the software flag is further used by the computer code to cause the first processor to reprocess the processor-specific data.
